(19) United States
(12) Patent Application Publication
(10) Pub. No.: US 2026/0280727 A1
(43) Pub. Date: Sep. 17, 2026

(54) SYSTEMS AND METHODS FOR TRANSMITTING COMMUNICATIONS AND POWER OVER LONG DISTANCES THROUGH TERRESTRIAL SUB-SURFACES

(71) Applicant: Tennessee Technological University, Cookeville, TN (US)

(72) Inventor: Charles W. Van Neste, Cookeville, TN (US)

(21) Appl. No.: 19/672,340

(22) Filed: May 8, 2026

Related U.S. Application Data
(63) Continuation-in-part of application No. 18/886,596, filed on Sep. 16, 2024.
Application No. 18/886,596 is a continuation of application No. 17/452,258, filed on Oct. 26, 2021, now Pat. No. 12,107,636.
(60) Provisional application No. 63/107,575, filed on Oct. 30, 2020.

(51) Int. Cl. H04B 13/02; H01P 3/00; H02J 50/20

(52) U.S. Cl. CPC H04B 13/02; H01P 3/00; H02J 50/20

(57) ABSTRACT

A system for transmitting power through a terrestrial body may include a transmitter electrode structure configured to be positioned within the terrestrial body. The transmitter electrode structure may include a first electrode and a second electrode spaced a distance from the first electrode. The system may include a power source electrically connected to the transmitter electrode structure and configured to drive an alternating current through the transmitter electrode structure and into the terrestrial body. The transmitter electrode structure may be configured such that an inductive reactance of a current path away from the transmitter electrode structure exceeds a contact resistance of the transmitter electrode structure, and the alternating current may flow through the current path to establish a reactive energy storage condition in the terrestrial body. The system may further include a receiver electrode structure configured to couple to the reactive energy storage condition and deliver power to a load.

### CROSS-REFERENCES TO RELATED APPLICATIONS

This application is a continuation-in-part of, and claims priority to and the benefit of U.S. Non-Provisional patent application Ser. No. 18/886,596, entitled “SYSTEM AND METHOD FOR GENERATING ELECTRIC BASED NON-LINEAR WAVES IN NATURAL TERRESTRIAL ENVIRONMENTS,” filed on Sep. 16, 2024, which is pending, which claims priority to U.S. Non-Provisional patent application Ser. No. 17/452,258, entitled “SYSTEM AND METHOD FOR GENERATING ELECTRIC BASED NON-LINEAR WAVES IN NATURAL TERRESTRIAL ENVIRONMENTS,” filed on Oct. 26, 2021, which claims priority to U.S. Provisional Patent Application No. 63/107,575, entitled “METHOD AND SYSTEM FOR GENERATING ELECTRIC NON-LINEAR WAVES IN NATURAL TERRESTRIAL ENVIRONMENTS,” filed Oct. 30, 2020, and which are incorporated by reference in their entireties.

### STATEMENT REGARDING FEDERALLY SPONSORED RESEARCH OR DEVELOPMENT

Research for this application was made possible with government support under Award Number 2226612 and Award Number 2451016 awarded by the National Science Foundation. The government has certain rights in the application.

### BACKGROUND

The present disclosure generally relates to the transmission of electrical signals or electrical power between desired systems or locations. More particularly, the present disclosure relates to the transmission of wireless electrical signals or electrical power over larger distances between two locations.

Conventional systems transfer electrical signals over large distances (i.e., greater than one meter) using wires connecting different systems. However, wired technologies are costly to install and maintain.

Some wireless power systems do exist. Such contemporary wireless power systems propagate electromagnetic (EM) fields from a transmission source to nearby electrical circuitry to induce a current in the nearby circuitry. One application of such contemporary wireless power transfer is charging systems for various electronics such as mobile phones, electric vehicles, and other various applications with rechargeable battery systems. Wireless power transmission can also be utilized to wirelessly power sensors or other electronic devices that can be at remote locations from a power transmission source.

However, even when using these contemporary wireless power solutions, long-distance energy transfer relies on low-efficiency EM space-wave techniques. Both surface and space wave EM propagation waves reduce quickly in amplitude over large distances. As such, in current wireless power transfer systems, the system to which power is transferred must be in close proximity to the transmitting power system. Technology involving the excitation of Zenneck surface waves to improve the attenuation rate of the EM energy, as described in U.S. Pat. No. 9,912,031 to Corum et al., do exist. While a marginal, close-range improvement may be accomplished utilizing these methods, the signal intensities are still limited and are not suited for wireless power transfer over long distances. Furthermore, such techniques are line-of-sight dependent, potentially dangerous to living beings, and prone to interference from environmental factors such as weather or fauna. Some of these issues can be mitigated by increasing the size of the transmitter or receiver. However, this also increases costs and is still susceptible to environmental factors.

When dealing with systems and methods related to sending electrical energy through a geological media, prior art has focused on far-field radiating electromagnetic wave principles, where energy is actively transferred from a transmission source to a receiver. Such prior art systems do not attempt to condition an electrode apparatus or operating frequency to establish a reactive energy store condition in the terrestrial body, and therefore, are limited in their ability to transfer power over long distances through a conductive geological media with low energy dissipation.

What is needed then are improvements in power transmission systems to allow for wireless power transmission over longer distances. Therefore, there is a long-felt but unresolved need for wireless power transmission systems that utilize near-field, non-radiating electromagnetic principles to enable efficient wireless power transmission over long distances through a terrestrial body.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

This disclosure provides systems and methods for propagating higher amounts of electric energy (relative to electromagnetic space and surface waves) over large distances. This enables the wireless transfer of power to loads in electrical connection (direct, capacitive, inductive) with the geological surface and subsurface. Such systems and methods provide for long-range wireless power transfer that is not line-of-sight dependent, is safe for living beings, and/or is resistant to environmental interference.

One aspect of the present disclosure is a system for transmitting electrical signals, including power and/or communications, through a terrestrial body having an upper surface. The system can include a transmitter including a first electrode positioned proximate the upper surface of the terrestrial body and a least one second electrode positioned beneath the surface of the terrestrial body and spaced from the first electrode. A power source can be operable to supply power to the first electrode and the at least one second electrode. A receiver assembly can be positioned proximate to or beneath the upper surface of the terrestrial body and spaced from the transmitter. When power is supplied to the transmitter, the transmitter produces an electric non-linear wave signal through the terrestrial body. The electric non-linear wave may be signal detectable by the receiver assembly. The dispersion and nonlinear characteristics of the terrestrial body can cancel one another out as an electrical signal passes through the terrestrial body to produce a propagating “pulse” electrical non-linear wave or signal that can travel over larger distances through the terrestrial body to the receiver assembly. In some embodiments, the non-linear wave can resemble, mimic, or be representative of a soliton wave.

The systems and methods of the present disclosure can be useful in wireless power transmission systems. Because of the increase in the transmission distances achieved, components in wireless transmission systems can be spaced apart from one another by more than a meter and still be in wireless communication with one another via the ground or the terrestrial body. Being able to wirelessly transmit power and/or communications over longer distances can help remove the need for cumbersome wiring setups that may need to be buried or covered depending on the environment. Additionally, because of the longer transmission range achieved by the systems and methods of the present disclosure, multiple objects to be powered can be spaced apart from one another and still be able to receive the electrical power signals propagated by a single transmitter or fewer transmitters. This can be particularly relevant for larger items such as vehicles or other large objects. In conventional power systems, multiple charging stations are required to charge multiple vehicles simultaneously. Certain systems and methods of the disclosure, however, can charge multiple vehicles using a single charging station. Furthermore, sensing or monitoring systems can also utilize the transmission systems and methods of the present disclosure to power numerous sensors, monitors, or other detection devices at varying locations and distances from the power transmitter.

One aspect of the present disclosure relates to systems and methods for transmitting power and/or communications through a terrestrial body using near-field, non-radiating electromagnetic principles. Power and communications may be transmitted simultaneously in some embodiments, although in some embodiments, power and communications may not be transmitted simultaneously (for example, they may be transmitted serially). Rather than relying on far-field radiating techniques that dissipate energy rapidly through conductive geological media, the disclosed systems establish a reactive energy storage condition in the terrestrial body by configuring a transmitter electrode structure such that the inductive reactance of the outward current path through the terrestrial body exceeds the contact resistance at the electrode-soil interface. This reactive energy storage condition allows energy to oscillate within the terrestrial body rather than being dissipated as heat, enabling efficient power transfer over long distances.

In some embodiments, a receiver electrode structure spaced apart from the transmitter electrode structure may be configured to couple to the reactive energy storage condition established in the terrestrial body and deliver power to a connected load, without the receiver electrode structure being connected to the transmitter electrode structure or an external power source. The systems and methods of the present disclosure may be useful in a variety of applications requiring wireless power transfer and/or communication through a terrestrial body, including mining, agriculture, defense, and power distribution, where traditional wired or far-field wireless approaches are impractical or inefficient.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a schematic view of one embodiment of a system of transmitting power and/or communications through a terrestrial body showing a transmitter and receiver of the system.

FIG. 2 is a perspective view of another embodiment of a system for transmitting power and/or communications through a terrestrial body having one transmitter and multiple receiver/transceiver assemblies positioned in the transmission range of the transmitter.

FIG. 3 is a cross sectional perspective view of a terrestrial body including another embodiment of a system for transmitting power and/or communications through the terrestrial body having a transmitter and a receiver assembly spaced from the transmitter.

FIG. 4 is a cross sectional perspective view of another embodiment of a transmitter for a system of transmitting power and/or communications through a terrestrial body.

FIG. 5 is a detailed cross sectional view of the transmitter of FIG. 4.

FIG. 6 is a graph of the resistance of the transmitter with the second electrode positioned at varying depths and operating at varying electrical frequencies.

FIG. 7 is a graph from an experimental transfer system incorporating certain systems and methods of the present disclosure showing differential surface voltages as a function of the distance away from the transmitter at varying currents supplied to a transmitter of the system.

FIG. 8 is a perspective view of an embodiment of a resonant antenna that can be utilized with the transmitter of FIGS. 1-4.

FIG. 9 is a cross sectional perspective view of a terrestrial body including another embodiment of a system for transmitting power and/or communications through the terrestrial body having a transmitter and multiple receiver assemblies.

FIG. 10 is a cross sectional perspective view of a terrestrial body including another embodiment of a system for transmitting power and/or communications through the terrestrial body having a transmitter and a receiver assembly spaced from the transmitter.

FIG. 11 illustrates a transmitter circuit.

FIG. 12 illustrates a system including the transmitter circuit and a receiver electrode structure.

FIG. 13 illustrates a circuit schematic of the system illustrated by FIG. 12.

FIG. 14 illustrates an experimental system.

FIG. 15 illustrates a surface electrode configuration.

FIG. 16 illustrates experimental results for the experimental system illustrated by

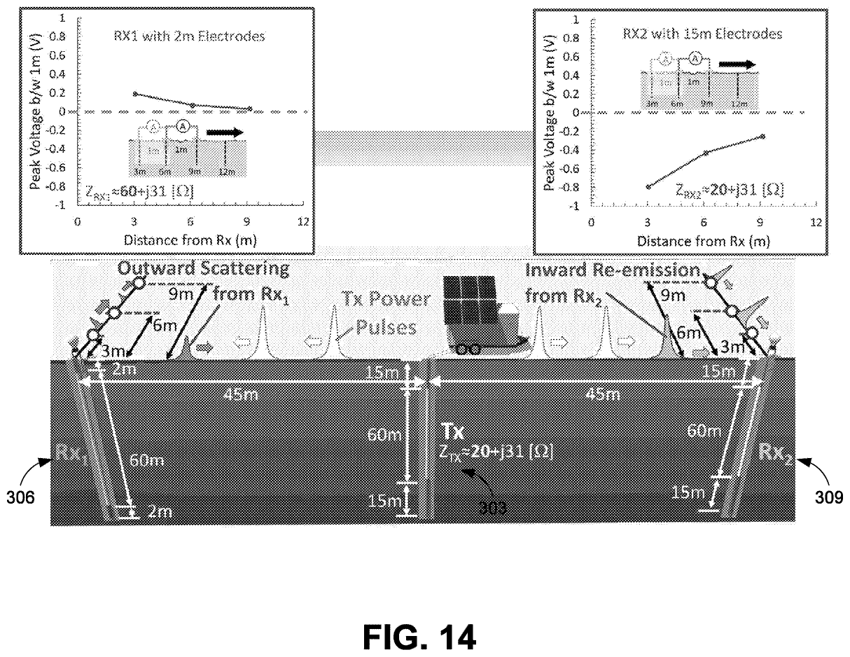

FIG. 14.

FIG. 17 illustrates a wireless powered communication network.

FIG. 18 illustrates an underground sensor.

FIG. 19 illustrates an access point receiver.

### DETAILED DESCRIPTION

Some examples of the disclosed technology will be described more fully with reference to the accompanying drawings. However, this disclosed technology may be embodied in many different forms and should not be construed as limited to the implementations set forth herein. The components described hereinafter as making up various elements of the disclosed technology are intended to be illustrative and not restrictive. Indeed, it is to be understood that other examples are contemplated. Many suitable components that would perform the same or similar functions as components described herein are intended to be embraced within the scope of the disclosed devices and methods. Such other components not described herein may include, but are not limited to, for example, components developed after development of the disclosed technology.

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

Throughout this disclosure, various aspects of the disclosed technology can be presented in a range of formats (e.g., a range of values). It should be understood that such descriptions are merely for convenience and brevity and should not be construed as an inflexible limitation on the scope of the disclosed technology. Accordingly, the description of a range should be considered to have specifically disclosed all the possible subranges as well as individual rational numerical values within that range. For example, a range described as being “from 1 to 6” or “from approximately 1 to approximately 6” includes the values 1, 6, and all values therebetween. Likewise, a range described as being “between 1 and 6” or “between approximately 1 and approximately 6” includes the values 1, 6, and all values therebetween. The same premise applies to any other language describing a range of values. That is to say, the ranges disclosed herein are inclusive of the respective endpoints, unless otherwise indicated.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicates that different instances of like objects are being referred to and are not intended to imply that the objects so described should be in a given sequence, either temporally, spatially, in ranking, or in any other manner.

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the illustrative examples provided in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Some nonlinear phenomena produce a wave that can propagate over very large distances and with very low attenuation when applied to natural environments (such as the Earth). In a lossy electromagnetic (EM) medium (i.e., a medium that has both a permittivity (¿) and a conductivity (o)), the wavenumber (k) becomes a complex value that is dependent on frequency. Thus, waves of different frequencies will propagate at different speeds. This effect is known as dispersion. Geological strata (soil, rock, etc.) is classically known as a lossy dielectric medium. EM waves that are propagated through terrestrial media will therefore suffer from dispersion.

Nonlinear effects are also prevalent in natural environments. One possible cause of the nonlinearity of the Earth comes from the atmosphere. Being a charged plasma, the capacitance the atmosphere makes with respect to the Earth's surface creates a non-linear capacitor (i.e., a capacitor whose value changes with applied voltage). With the surface coupled to the atmosphere, a strong perturbation created at the surface will induce a slight modulation of the sky/surface capacitance. Such a modulation of the plasma has been shown accidently in the Luxembourg Effect of 1933, and purposely in the 1980s by the High Frequency Active Auroral Research Program (HAARP). See also U.S. Pat. No. 4,686,605 to Eastlund. However, both of these demonstrated modulations occurred due to EM energy bombardment from a surface antenna of intense power magnitudes. Other forms of nonlinearity also exist, specifically in soil/rocks, where ionic liquid interactions with applied voltages and currents can create perturbations in ion transport that are dependent on the magnitudes of the applied voltages. One example of this is oxidation-reduction reactions, common in soils with mineral content, which have reaction rate constants that are both exponential and voltage dependent.

If a system possesses both dispersion and non-linearity, it is possible in some cases to create a non-linear wave form, or a wave described by a non-linear equation with such a system. One such non-linear wave phenomenon is known as a soliton wave. A soliton wave takes the form of a propagating “pulse” where the normal dispersion effects are canceled by the nonlinearity of the medium. The soliton wave pulses can generally be modelled by the following equation:

$$u ( x , t ) = A {sech}^{2} ( \sqrt{\frac{A}{2}} ( x - 2 A t ) ) \qquad ( 1 )$$

where A is the current amplitude, x is the spatial coordinate and t is the temporal coordinate.

These waves are special in that they may propagate over very large distances, have a velocity dependent on their amplitude (c=24 as shown in Eq. 1), and do not superimpose with other soliton waves. Instead, they elastically collide (like a particle), reforming back to their original pre-collision amplitudes and widths after crossing. With the Earth supporting both dispersion and non-linearity, the generation of non-linear waves (including soliton waves) can be possible with a strong enough current impulse in the medium.

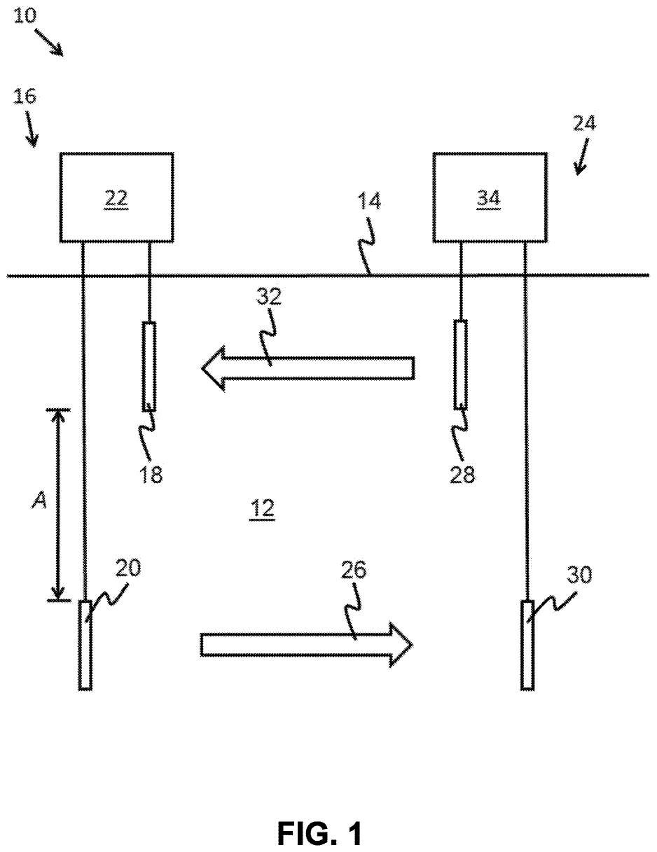

FIG. 1 depicts one aspect of the present disclosure. FIG. 1 depicts one embodiment of a system 10 for transmitting electrical signals through a terrestrial body 12 having an upper surface 14. The system 10 can include a transmitter 16. The transmitter 16 may include a first electrode 18 positioned proximate the upper surface 14 of the terrestrial body 12 and a least one second electrode 20 positioned beneath the upper surface 14 of the terrestrial body 12 and spaced from the first electrode 18. A power source 22 can be operable to supply power to the first electrode 18 and the at least one second electrode 20. A receiver assembly 24 can be positioned proximate to or beneath the upper surface 14 of the terrestrial body 12 and spaced from the transmitter 16. When power is supplied to the transmitter 16, the transmitter 16 produces an electric non-linear wave signal 26 through the terrestrial body 12. The electric non-linear wave signal 26 may be detectable by the receiver assembly 24. The dispersion and nonlinear characteristics of the terrestrial body 12 can cancel one another out as an electrical signal is passed through the terrestrial body 12 to produce a propagating “pulse” electrical non-linear wave signal 26 that can travel over larger distances through the terrestrial body 12 to the receiver assembly 24 spaced from the transmitter 16. In some embodiments, the non-linear wave signal 26 propagated by the transmitter 16 through the terrestrial body 12 can resemble, mimic, or be representative of a soliton wave. In some embodiments, the non-linear wave signal 26 may include a conduction current over and through the terrestrial body 12.

Note that the Earth is used as an example of a terrestrial body, as applications and experiments have thus far been conducted on Earth. However, this does not exclude other terrestrial bodies such as other planets, moons, asteroids, etc. that could also serve as a terrestrial body. The terrestrial body may include soil, rock, dirt, etc., and may be natural or artificially created. In some cases, the terrestrial body may include subsurface materials, although in some cases, the terrestrial body may include materials that are not subsurface, e.g., rocks piled on the surface of the earth. In another embodiment, the terrestrial body may include water.

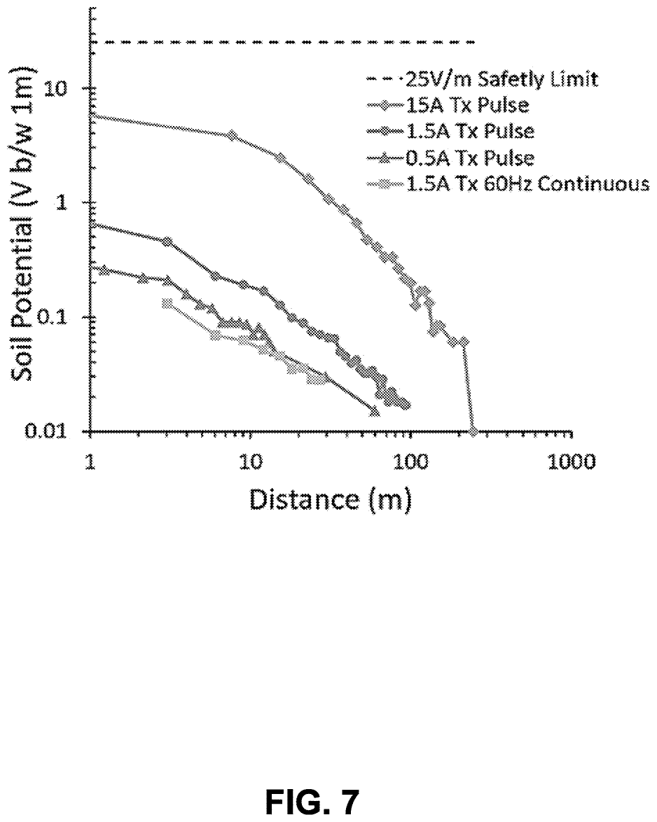

When power is supplied to the first and second electrodes 18, 20, a high intensity current pulse can be generated between the two electrodes 18, 20. The intensity of the pulse dictates the distance and speed of the non-linear wave signal 26 generated. FIG. 7 is an example plot of the detected voltage versus distance for increasing current impulses. It can be seen that as the impulse current increases, the magnitude of the pulse of the non-linear wave signal 26 extends farther and diminishes lower in amplitude with distance. In some embodiments, the receiver assembly 24 can detect a voltage of at least 5 volts for the electric non-linear wave signal 26 when the receiver assembly 24 is spaced at least 3 meters from the transmitter 16 and an impulse current of 15 amps is provided to the transmitter 16. In some embodiments, the receiver assembly 24 can detect a voltage of at least 0.1 volts for the electric non-linear wave signal 26 when the receiver assembly 24 is spaced at least 3 meters from the transmitter 16 and an impulse current of 0.5 amps is provided to the transmitter 16. In some embodiments, the receiver assembly 24 can detect a voltage of at least 0.5 volts for the electric non-linear wave signal 26 when the receiver assembly 24 is spaced at least 3 meters from the transmitter 16 and an impulse current of 1.5 amps is provided to the transmitter 16. These threshold transmission values can represent the detection of a significant voltage signal at a relatively large distance from a transmission source with a relatively small impulse current applied to the transmitter 16. This can provide an advantage over some prior art systems that have seen some propagation of small voltage signals across large distances, but an extremely large current input, and thus power input, was required. In one embodiment, the potential voltage received by the transmitter 16 can modeled based on the following equation:

$${V}_{V} ≅ \frac{9 I * {d}^{4}}{4 π {σ}^{5}} \qquad ( 2 )$$

where I is the current that is being projected by the bottom electrode 20, σ is the conductivity of the soil surrounding the system, r is the distance between the transmitter 16 and receiving circuits, and dis the distance between the first and second electrodes 18, 20 of the transmitter 16.

In some embodiments, the at least one second electrode 20 can be spaced a vertical distance A downward (or in any other suitable direction) from the first electrode 18. The vertical distance A may include the distance d from Equation 2. In some embodiments, the receiver assembly 24 can include a first receiver electrode 28 positioned proximate the upper surface 14 of the terrestrial body 12 and a least one second receiver electrode 30 positioned beneath the upper surface 14 of the terrestrial body 12 and spaced at the distance A from the first receiver electrode 28. The receiver assembly 24 may be operable to propagate a return electric non-linear wave signal 32 through the terrestrial body 12, the return electric non-linear wave signal 32 being detectable by the transmitter 16. Thus, a complete return path can be formed underground by using the soil or terrestrial body 12 as a conductive medium between the first and second electrode 18, 20 pairs of the transmitter 16 and the receiver assembly 24. In some embodiments, the distance between the first and second electrodes 18, 20 and the first and second receiver electrodes 28, 30 can be substantially equal.

In some embodiments, the distance between the first receiver electrode 28 and the at least one second receiver electrode 30 may be less than the distance A. This configuration of the distance between the first receiver electrode 28 and the at least one second receiver electrode 30 may be applicable to systems 10 where the transmitter 16 is operable to transmit in a low-power mode. In one embodiment, the distance between the first receiver electrode 28 and the at least one second receiver electrode 30 may be substantially equal to the distance A.

In some embodiments, the receiver assembly 24 can be a transceiver that can both receive an electric non-linear wave signal 26 from the transmitter 16 and provide a return non-linear wave signal 32 to the transmitter 16. In some embodiments, as shown in FIG. 1, the return non-linear wave signal 32 can be propagated through the terrestrial body 12 similarly to the non-linear wave signal 26 provided to the receiver assembly 24 by the transmitter 16. In some embodiments, this may be used to facilitate communication between a transmitter and a receiver assembly.

In some embodiments, the power source 22 may include a geothermal heat pump (GHP), a solar panel array, a wind turbine, a hydroelectric generator, a power plant (which may generate power via fossil fuels or nuclear fission), a hydrogen fuel cell, a battery, or some other power source. The power source 22 may include a power outlet connected to one or more of the power source previously mentioned.

In some embodiments, the first electrode 18 may include a water well casing, an oil well casing, or some other type of well casing or other type of casing. The first electrode 18 may include a modified vertical ground heat pump tubing, and the second electrode 20 may include the chassis of a submersible pump, a steam-assisted gravity drainage tubing, a fracking tubing, or a modified vertical ground heat pump tubing.

In one embodiment, the power source 22 may include an electric inverter. The electric inverter may shape the power waveform into a high-intensity pulse. The high-intensity pulse may include the electrical non-linear wave signal 26. The electrical non-linear wave signal 26 may include a rapid conduction current that may propagate outward within the surrounding terrestrial body 12.

In one embodiment, the power source may include a modulator. The modulator may modulate the power that is supplied to the electrodes to encode a communication to be transmitted by the transmission device, for example, a wireless communication such as those described herein. The communication can be any encodable communication, e.g., data, text, sound, images, photographs, etc. A variety of techniques may be used to modulate the power to encode data. As non-limiting examples, frequency modulation (FM) or AM amplitude modulation (MD) may be used to modulate the signal to encode a communication. Other non-limiting examples of signal modulation that could be used include pulse position modulator, phase shift keying (PSK), frequency-shift keying (FSK) such as binary frequency-shift keying (BFSK), amplitude shift keying (ASK), quadrature amplitude modulation (QAM), Morse code, or the like. The communication, in some embodiments, may be directed at any suitable target, e.g., to one or more receiver assemblies, to an external target, or the like.

In addition, in some embodiments, one or more receiver assemblies may include a modulator, independently of whether the power source in the transmitter includes a modulator. The modulator may be any of the modulators described herein. If more than one modulator is present in a system (for example, within two or more receivers, within a transmitter and a receiver, etc.), the modulators may independently be the same or different. In some embodiments, one or more receiver assemblies that include a modulator may be able to transmit a communication, e.g., to the transmitter, to another receiver, and/or to an external target, etc.

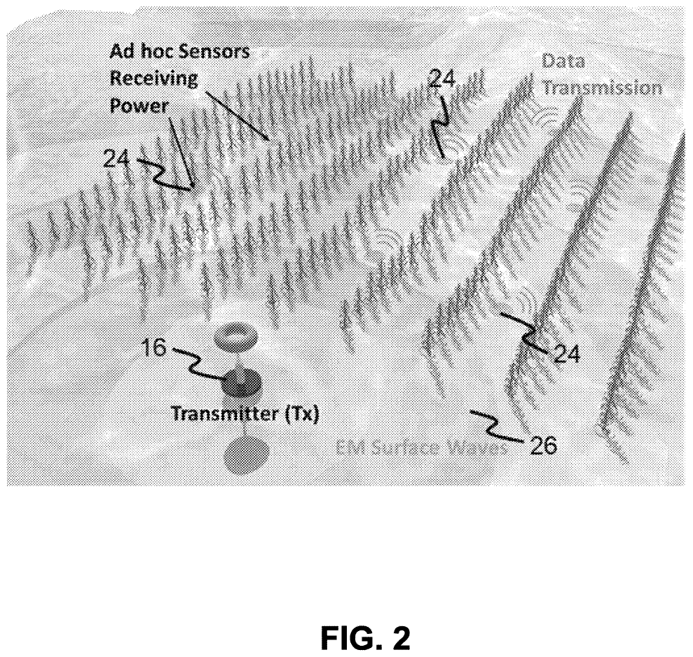

FIG. 2 depicts another embodiment of the system 10. The system 10 may include one or more components depicted in FIG. 1 such as the transmitter 16, one or more receiver assemblies 24, or an electric non-linear wave signal 26. In some embodiments, the receiver assembly 24 can have additional hardware and control circuitry 34 which can be powered by the electrical non-linear wave signal 26 but which can include an above ground antenna for sending a wireless telemetry signal, such as a radio frequency signal back to the transmitter 16 or another source. For instance, in some embodiments, the receiver assembly 24 can be a sensing device that can be powered by the non-linear wave signal 26 and can include wireless telemetry circuitry that can provide a wireless communication signal back to the transmitter 16 or another source, as shown in FIG. 2.

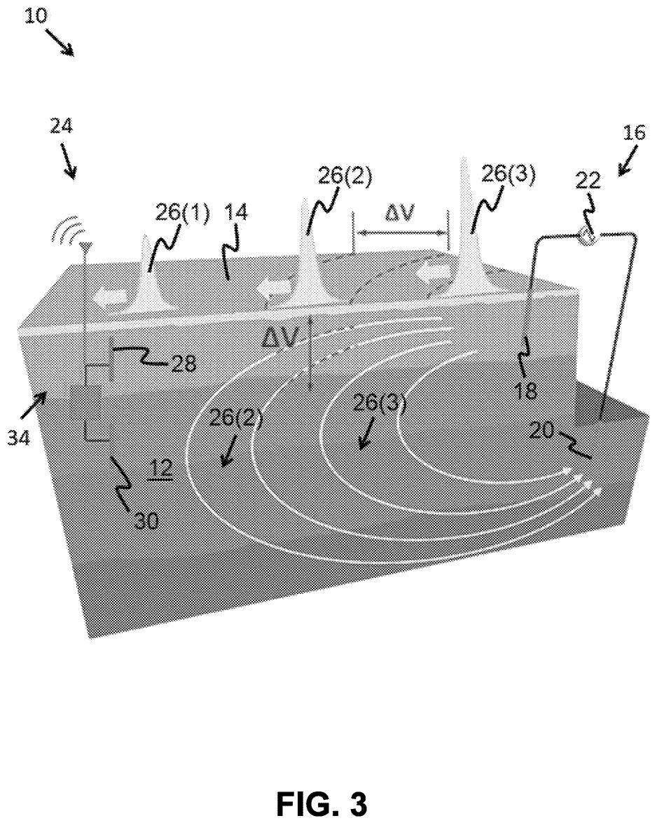

FIG. 3 depicts another embodiment of the system 10. The system 10 may include one or more components discussed previously with regards to FIG. 1 or FIG. 2 such as the terrestrial body 12 and its upper surface 14, the transmitter 16, the first and second electrodes 18, 20 of the transmitter 16, the power source 22, the receiver assembly 24, one or more electrical non-linear wave signals 26(1)-(3), the first and second receiver electrodes 28, 30. In some embodiments, the additional hardware and control circuitry 34 of the receiver assembly 24 may include a buried sensor. The buried sensor may receive signals from the first or second receiver electrodes 28 or 30. The additional hardware and control circuitry 34 may include an antenna that may transmit sensor data from the buried sensor. In some embodiments, the distance between two electrical non-linear wave signals 26(1)-(3) may include the potential difference ΔV in the terrestrial body 12.

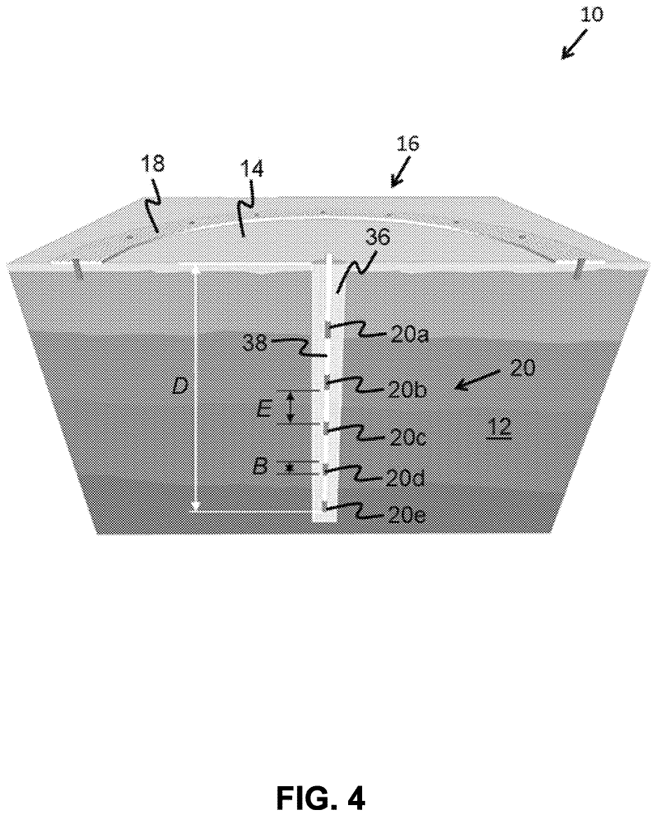

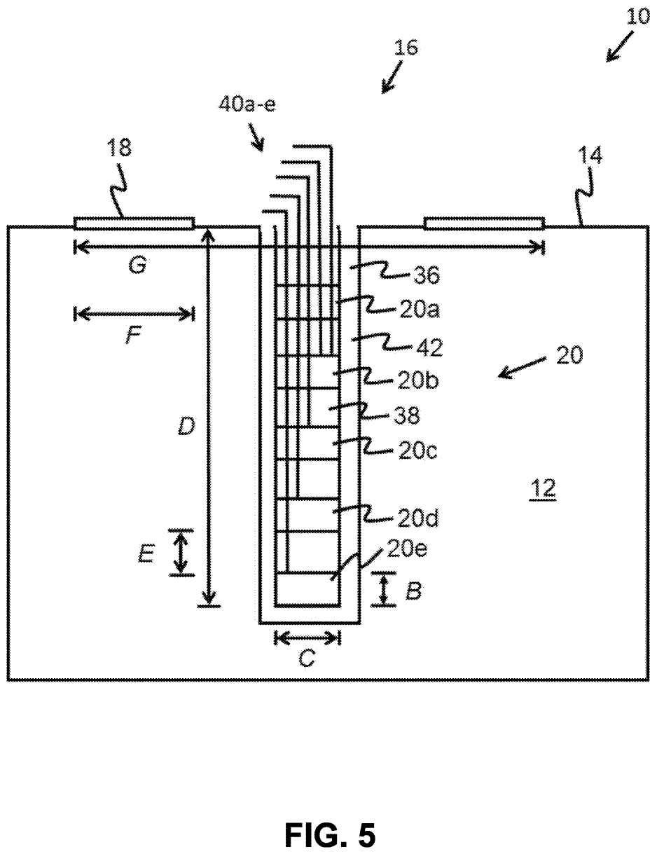

FIG. 4 and FIG. 5 depict one embodiment of the system 10. The system 10 may include a transmitter 16. In some embodiments, the second or bottom electrodes 20 of the transmitter 16 can be buried in a bore well 36 beneath the upper surface 14 of the terrestrial body 12 such that the second electrodes 20 are bore electrodes having the shape of a cylinder or a cylindrical ring. In one embodiment, a second electrode 20 may include a height B. The height B can be between about 2 and 20 meters in some embodiments. A large surface area of the at least one second electrode 20 can produce larger current amplitudes in the resulting non-linear waves 26 propagated in the terrestrial body 12. Increasing the height B of the second electrode 20 can increase the surface area of the second electrode 20 while helping to minimize the width or diameter C of the second electrode 20 and, in some embodiments, the width of the bore well 36 that would need to be drilled to accommodate the second electrode 20. In some embodiments, the width or diameter C of the second electrode 20 and, thus, the bore well 36 can be less than 0.3 meters. In one or more embodiments, the width of the bore hole may be different that the width or diameter C of the second electrode 20.

In some embodiments, the system 10 may include multiple bore wells 36. One or more of the bore wells 36 may be similar to the bore well depicted in FIG. 3, FIG. 4, or FIG. 5. A bore well 36 may be connected to a power source 22. The multiple bore wells 36, together, may form part of a large transmitter 16. The transmitter 16 may include very low electrical impedance between the multiple first electrodes 18 and the multiple second electrodes 20.

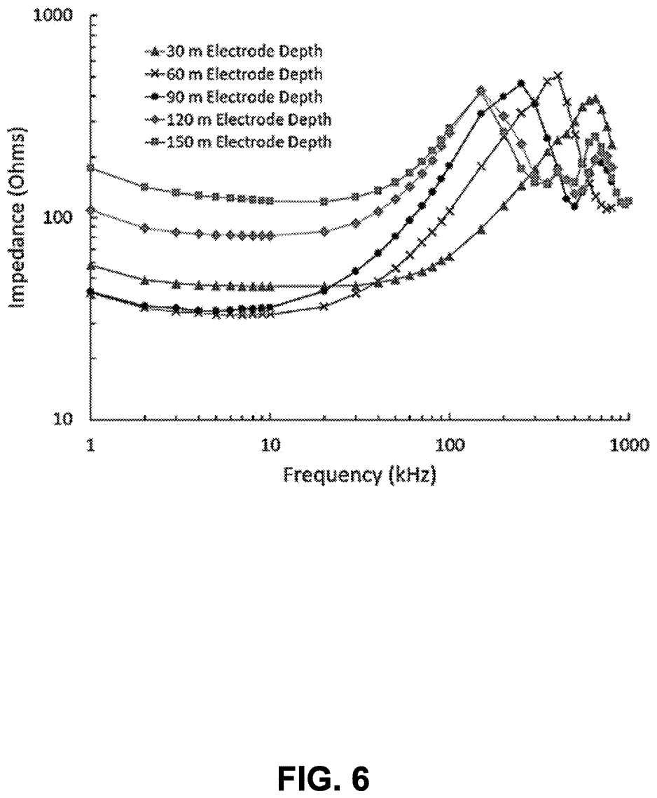

In some embodiments, the impedance of the first electrode 18 and the second electrode 20 should be as low as possible in order to promote as high a current density as possible with the lowest amount of joule heating loss (i.e., resistive losses due to the terrestrial medium's 12 conductivity). As shown in FIG. 6, it has been found that the depth D of the second electrode 20 beneath the first electrode 18 can affect the impedance of the transmitter 16 and, thus, the current amplitude of the non-linear wave signal 26 produced by the transmitter 16 at a consistent voltage input. For one experimental environment, the impedance of the transmitter 16 was generally lower when the second electrode 20 was positioned at a depth D of between about 30 and 90 meters beneath the upper surface 14 of the terrestrial body 12 and the first electrode 18, with the impedance generally lowest at a depth D of about 60 meters. In some embodiments, a deeper at least one second electrode 20 positioned at a depth D of 120 and 150 meters may show a greater impedance as the depth D gets lower into the terrestrial body 12. The increased impedance at greater depths D may be caused by the water table levels or conductive properties or material composition of the terrestrial body 12 at the further depths. However, depending on the soil environment at a particular location, optimal second electrode 20 depths D may vary from location to location.

In some embodiments, as shown in FIG. 4 and FIG. 5, the at least one second electrode 20 can include a plurality of second electrodes 20. The plurality of second electrodes 20 may include five second electrodes 20a, 20b, 20c, 20d, and 20e disposed below a height of the first electrode 18. The plurality of second electrodes 20a, 20b, 20c, 20d, and 20e can be spaced apart from one another at varying distances E. In one embodiment, the distance E between to second electrodes 20 may be at least 30 meters. Power can be supplied to each of the second electrodes 20a, 20b, 20c, 20d, and 20e. In some embodiments, the at least one second electrode 20 may include more than five second electrodes or fewer than five second electrodes.

In one embodiment, as shown in FIG. 5, the transmitter 16 can have a depth D. The depth D may be a distance between about 150 and 180 meters. The second electrodes 20a, 20b, 20c, 20d, and 20e may each have a diameter C of between about 0.1 and 0.5 meters. In one embodiment, each second electrode 20a, 20b, 20c, 20d, or 20e may include a vertical brass pipe of a height B. The height B may be approximately at least 2 meters. The second electrodes 20a, 20b, 20c, 20d, and 20e may be separated from each other by long increments of insulated plastic tubing sections 38. An insulated plastic tubing section 38 may have a height E. Each second electrode 20a, 20b, 20c, 20d, or 20e may be connected to the power source 22 at the surface 14 by a high-insulated copper wire 40a, 40b, 40c, 40d, 40e. In some embodiments, the depths D of the second electrodes 20a, 20b, 20c, 20d, and 20e can be from 20-50 meters, 51-80 meters, 81-110 meters, 111-140 meters, and 141-170 meters, respectively, with the insulated plastic tubing sections 38 having lengths E of about 25-35 meters. Varying depths D for the second electrodes 20a, 20b, 20c, 20d, or 20e can be used depending on the terrestrial body 12 environment. In other embodiments, the height B of a second electrode 20a, 20b, 20c, 20d, or 20e could have a height between 2 and 20 meters. In such instances, the heights E of the plastic tubing section 38 between the brass pipes 20 may have a height between about 10 and 30 meters. In some embodiments, the bore well 36 of the transmitter 16 can be filled with bentonite clay 42. The bentonite clay 42 may have varying electrical conductivity. The bentonite clay 42 may protect the water table from being contaminated. Lastly, the first electrode 18 proximate the surface 14 of the terrestrial body 12 can be a galvanized steel mesh that may have a width F. The width F may be a width of approximately 0.75 to 1.25 meters. In some embodiments, the first electrode 18 may have a diameter G. The diameter G may have a diameter of approximately 16-20 meters. The bore well 36, and thus, the second electrodes 20a, 20b, 20c, 20d, and 20e, may be disposed at the center of the diameter G.

Having a transmitter 16 with multiple second electrodes 20 at varying depths can help avoid the need to test for an optimal depth of the second electrode 20 at a particular location. One or more of the second electrodes 20 can provide adequately low impedance and, thus, higher current transmission of the non-linear wave signal 26 once the transmitter 16 is installed in the ground and a pulse wave power signal is supplied to the transmitter 16 to achieve the desired power transmission to the receiver assembly 24.

The frequency of the electrical impulse signal provided to the transmitter 16 can also affect the impedance of the transmitter 16 and, thus, the current amplitude of the electrical non-linear wave signal 26. As shown in FIG. 6, impedance is lower at frequencies of between about 1 and 50 kHz. In some embodiments, a frequency of between about 25 and 35 kHz may optimize the impedance of the transmitter 16. In some other embodiments, other frequencies may optimize the impedance of the transmitter 16.

In some embodiments, the power source 22 or other circuitry the transmitter 16 may modulate the pulse repetition rate at a particular lower frequency. This may enable the build-up of energy in a tuned resonant circuit at the receiver 24. In some cases, the modulation may be used to encode a communication, e.g., as described herein.

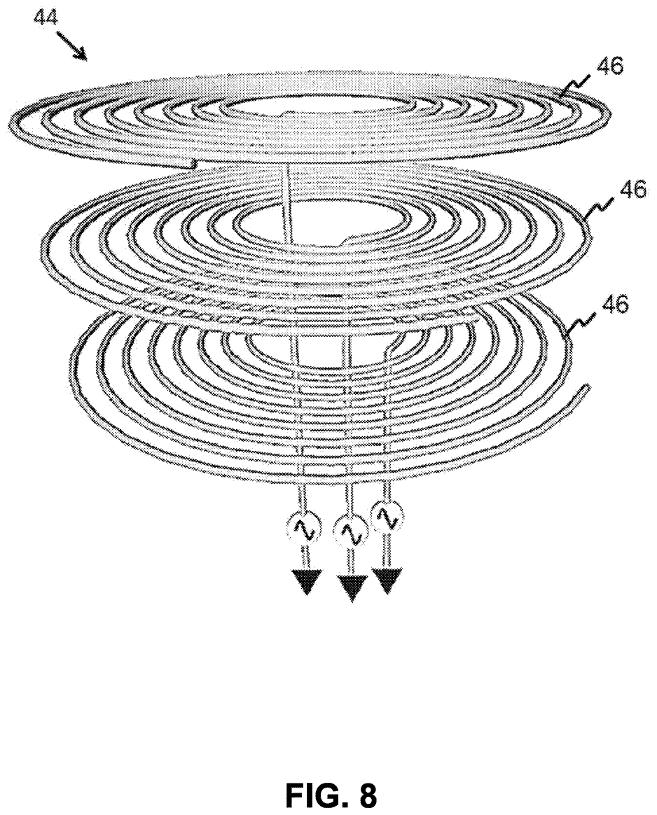

In some embodiments, as shown in FIG. 8, the system 10 may include a resonant antenna 44. The first electrode 18 may include the resonant antenna 44. The first receiver electrode 28 may include the resonant antenna 44. In some embodiments, the resonant antenna 44 may be elevated and extend above the terrestrial body's 12 upper surface 14. In one embodiment, the resonant antenna 44 may function as a tuned circuit at the receiver 24 for building up the transmitted pulse energy and improving the maximum power transfer.

In one embodiment, the resonant antenna 44 may include one or more coil sections 46. Each coil section 46 may include a resonant frequency (f). The resonant frequency of a certain coil section 46 may be a multiple of the resonant frequency of the proceeding coil section 46. One or more power sources 22 may excite a coil section 46 that contains the same frequency as that coil section's 46 resonant frequency. When a coil section 46 is excited at its resonant frequency, the resonant antenna 44 may produce a standing wave in that coil section 46. The electric and magnetic field of the standing wave in the coil sections 46 may superimpose to create a Fourier summation of the fields. Thus, the total waveform of the resonant antenna 44 may not include a sine wave (as is the case of prior art antennas) but may include a shape defined by the summation of one or more of the coil sections 46 following a Fourier series. This resonant antenna 44 may create extremely high voltage electric field impulses that may further increase the impulse excitation to produce non-linear wavers within the terrestrial body 12.

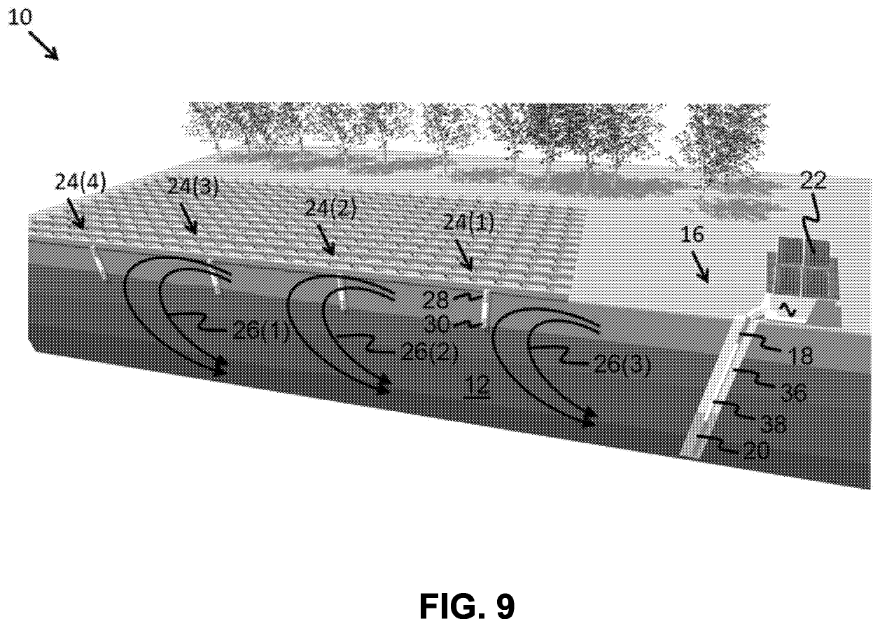

FIG. 9 depicts one embodiment of the system 10. The system 10 may include one or more components as have been described previously as being included in the system 10. For example, the system 10 of FIG. 9 may include a transmitter 16 with its respective first electrode 18, second electrode 20, power source 22 bore well 36, insulated plastic tubing section 38. The system 10 may include one or more receiver assemblies 24(1)-(4). Each receiver assembly 24 may include its respective first receiver electrode 28 and second receiver electrode 30. In some embodiments, an insulated plastic tubing section 38 may be disposed between the first and second receiver electrodes 28, 30.

As can be seen in FIG. 9, the power source 22 may include a solar panel array and may include an inverter. Other power sources can be used in other embodiments, e.g., as discussed herein. As can also be seen, in some embodiments, the first and second receiver electrodes 28, 30 of one or more of the receiver assemblies 24(1)-(4) may form a line with the transmitter's 16 first and second electrodes 18, 20.

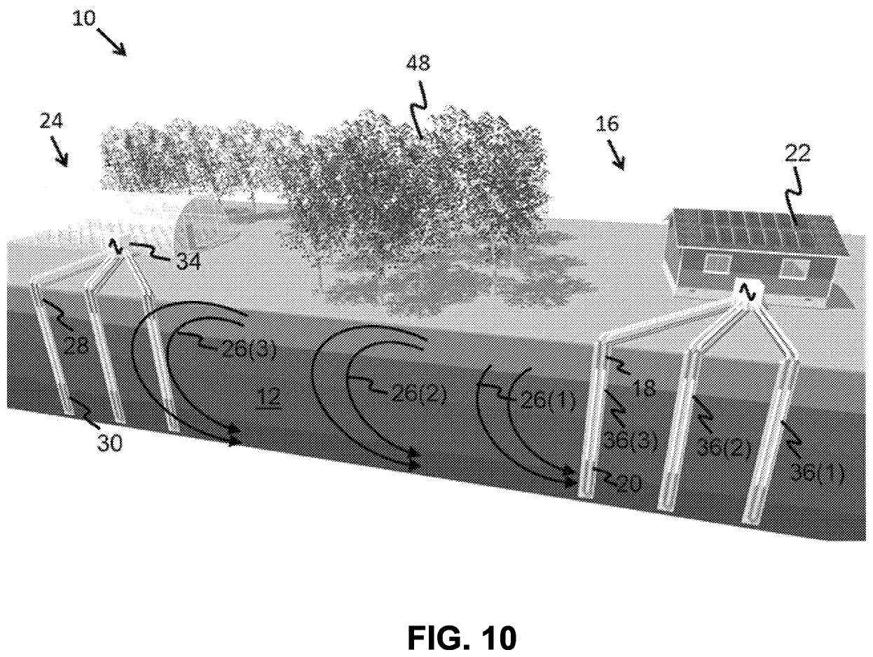

FIG. 10 depicts one embodiment of the system 10. In one embodiment, the system 10 may include a transmitter 16. The transmitter 16 may include a power source 22 (e.g., as depicted in FIG. 10, a solar panel array). The transmitter 16 may include multiple bore wells 36(1)-(3). For example, as depicted in FIG. 10, the transmitter 16 may include a first bore well 36(1), which may include a first vertical ground heat exchanger (VGHE). The transmitter may include a second bore well 36(2), which may include a second VGHE. The power source 22 may connect to an inverter and may supply power to the first electrode 18 and the second electrode 20 of the transmitter 16.

As can be seen in FIG. 10, in some embodiments, the transmitter 16 may include a U-tube. The U-tube may include the first electrode 18 and the second electrode 20. A U-tube may include an assembly that includes two separate vertical shafts and a U-shaped connection that form a U-shaped configuration. The first electrode 18 may include two separate electrodes each disposed near the top of a shaft of the U-tube, and the second electrode 20 may include a U-shaped electrode disposed at the bottom of the shafts that forms the U-shaped connection. In some embodiments, the U-tube may include a high-density polyethylene (HDPE). The HDPE may include one or more wires (such as the copper wire 40) disposed outside the HDPE to supply power to the first and second electrodes 18, 20. In one embodiment, the transmitter 16 may include multiple U-tubes that may include the first and second electrodes 18, 20. The U-tube may be disposed in a bore well 36 (e.g., as shown in FIG. 10, the third bore well 36(3)).

As can also be seen in FIG. 10, the receiver assembly 24 may include one or more bore wells 36. A bore well 36 of the receiver assembly 24 may include a VGHE. A bore well 36 of the receiver assembly may include a U-tube. The U-tube of the receiver assembly 24 may be similar to the U-tube of the transmitter 16, except the U-tube of the receiver assembly 24 may include the first and second receiver electrodes 28, 30. Furthermore, as depicted in FIG. 10, the receiver assembly 24 may include multiple U-tubes.

In some embodiments, the transmitter 16 or receiver assembly 24 may include one or more U-tubes because the transmitter 16 or receiver assembly 24 geometries may be very similar to the geometry used in commercial VGHEs. This may allow the easy integration of long-range wireless power transfer technology into a VGHE installation. The dual functionality of the transmitter 16 or receiver assembly 24 and VGHE system may enhance construction efficiency and offer a way to supply power to buildings in remote areas.

As can be seen in FIG. 10, in some embodiments, an obstacle 48 may be disposed between the transmitter 16 and the receiver assembly 24. The obstacle 48 may obscure a line of sight between the transmitter 16 and the receiver assembly 24. However, because the non-linear wave signals 26(1)-(3) travel through the terrestrial body 12, the obstacle 48 does not interfere with the wireless power transfer of the system 10.

In one or more embodiments, the power provided from non-linear wave signals 26 may power components associated with the respective transmitter 16 or receiver assembly 24. For example, power generated from non-linear wave signals 26 received by the receiver assembly 24 may power components of a greenhouse (e.g., lighting, sensors, etc.) that may be electrically connected to the receiver assembly. Power generated from non-linear wave signals 26 received by the receiver assembly 24 may power VGHE components (e.g., pumps). Power generated from non-linear wave signals 26 received by the transmitter assembly 16 may power VGHE components electrically connected to the transmitter 16.

In some embodiments, other EM wave phenomena (space waves, surface waves, etc.) are used to generate the non-linear wave signals 26, e.g., through secondary processes. In one or more embodiments, the transmitter 16 and/or receiver 24 electrode 18, 20, 28, 30 configuration can be utilized to harvest or collect electrical power from the terrestrial body 12 or from telluric currents propagated through the terrestrial body 12. The telluric currents can be a result of man-made or natural causes. For instance, stray electrical signals from buried or surface power lines, lightning strikes, the terrestrial geoelectric circuit, or other sources of electrical energy may propagate through the terrestrial body 12. The harvesting of such electrical signals and electrical power via the electrode 18, 20, 28, 30 setup of the system 10 can help offset the power requirements needed to transmit adequate power via the transmitter 16/receiver 24 setup through the terrestrial body 12.

Certain systems and methods of the disclosure overcome the disadvantages of prior efforts at wireless transmission over long distances, e.g., of power and/or communications. With the majority of the electrical non-linear wave signal 26 propagating at or below the surface 14, such non-linear wave signals 26 are safe for living beings on the surface 14. Furthermore, environmental factors, such as weather or birds, do not interfere with the electrical non-linear wave signals 26. Changes in conductivity, such as changes from a building's foundation rebar, soil strata, etc., within a geological strata layer generally occur horizontally. Thus, such changes in conductivity may not shunt the flow of the non-linear wave signals 26. Furthermore, the non-linear wave signals 26 travel along the surface 14 contours (e.g., up slopes, down into valleys, etc.). This allows for potential surface coupling effects as the electrical non-linear wave signals 26 travel outwards from the transmitter 16. This also allows the transmitter 16 and the receiver 24 to function even when they are not within line-of-sight of each other.

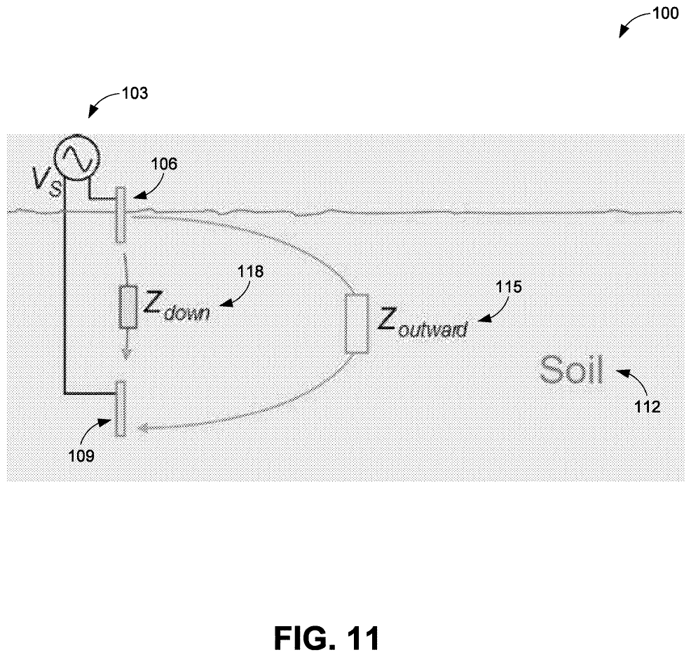

Referring now to FIG. 11, shown is an example transmitter circuit 100 for transmitting communications and/or power through terrestrial subsurfaces. The transmitter circuit 100 can include a power source 103, represented as Vₛ, a first electrode 106, and a second electrode 109. The first electrode 106 and the second electrode 109 can be placed in a terrestrial body (e.g., Earth, the Earth's moon, other planets and moons, asteroids) and separated by a distance. For example, the first electrode 106 and the second electrode 109 can be placed in the Earth and separated by the soil 112. In some embodiments, the first electrode 106 may be referred to as a surface electrode, and the second electrode 109 may be referred to as a subsurface electrode. In some embodiments, the transmitter circuit 100 can include more than one surface electrode and more than one subsurface electrode. The power source 103, Vₛ, can include an AC power source connected to the first electrode 106 and the second electrode 109. The power source 103 can inject an AC current into the terrestrial body via the first electrode 106 and the second electrode 109. The circuit 100 can be configured to cause the terrestrial body to act as an inductor and cause an outward impedance 115, Z_{outward}. As will be further discussed herein, the outward impedance 115 can cause a reactive power flow, which can be used to power a load or provide communications to other electrodes placed in the terrestrial body without connecting those electrodes to a power source. For example, certain systems and methods described herein may be used for any application requiring wireless power transfer and/or communication through a terrestrial body, including but not limited to mining, agriculture, defense, and power distribution. As non-limiting illustrative examples, the described systems and methods can be used to power a network of underground sensors, monitoring devices, and other electrical loads across an area of a terrestrial body without requiring wired connections and/or independent power sources at each device.

As will be understood by those having skill in the art, electrical impedance, Z, can be represented as:

$$Z = R \pm j X \qquad ( 3 )$$

where R represents resistance, which indicates a dissipative energy loss, X represents reactance, which indicates energy that is momentarily stored in one-half cycle and then returned to the energy supply in the next half-cycle, and j is an imaginary number. A current, supplied by the power source 103, can travel down (e.g., from the first electrode 106 to the second electrode 109) and outward (e.g., away from the first electrode 106 and second electrode 109). For example, the downward current path can be characterized by a downward impedance 118, Z_{down}, which can have a predominantly resistive character (e.g., the dissipative energy loss can be greater than the non-dissipative reactance). The resistive character of the downward impedance 118 can be caused by the contact resistance at the first electrode 106, R_{contact}. As another example, the outward current path can be characterized by the outward impedance 115, Z_{outward}. In some embodiments, the transmitter circuit 100 can be configured such that the outward impedance 115 will include a predominantly inductive reactive character (e.g., the non-dissipative reactance is greater than the dissipative resistance).

For example, in some embodiments, the circuit 100 can be configured such that the contact resistance, R_{contact}, can be minimized while the outward reactance, X_{outward}, which can satisfy the condition X_{outward}>>R_{contact}. When the condition X_{outward}>>R_{contact} is met, the circuit 100 can be configured to provide power to another electrode (e.g., a load) placed in the terrestrial body without the electrode being connected to the transmitter circuit 100. When the condition X_{outward}>>R_{contact} is satisfied, the energy supplied by the power source 103 can oscillate between the transmitter circuit 100 and the terrestrial body rather than being dissipated as heat in the terrestrial body. In some embodiments, during each half-cycle of the AC power, the energy may flow outward away from the transmitter circuit 100, and during each subsequent half-cycle, the stored energy may return to the power source. In some embodiments, a receiver electrode structure can be placed into the terrestrial body and spaced apart from the transmitter circuit 100. This receiver electrode structure can be configured to couple to the reactive energy field established in the terrestrial body, such that the receiver electrode structure may extract power from the oscillating energy field (e.g., couple to the energy storage condition) and deliver it to a load connected to the receiver electrode structure. Thus, the transmitter circuit 100 can be configured to provide power to a receiver electrode structure without that receiver electrode structure being connected to the transmitter circuit 100 or an external power source (e.g., power source 103).

In some embodiments, the power source 103 may be configured to operate in a continuous waveform mode such that a sinusoidal AC signal is driven through the transmitter circuit 100 at the resonant frequency, establishing a reactive energy field in the terrestrial body with very little energy dissipated in the terrestrial body. In some embodiments, the continuous waveform mode may support communication through frequency modulation (FM) or amplitude modulation (AM) of the AC signal. In some embodiments, the power source 103 source may be configured to operate in a pulsed mode wherein pulses of high current are driven through the transmitter circuit 100 and into the terrestrial body. In some embodiments, the pulsed mode may support communication through pulse position modulation or frequency shift keying (FSK), for example, binary frequency-shift keying (BFSK), or through other techniques such as Morse code. In some embodiments, when pulses of high current are used, the power source input voltage pulse may have a significant delay relative to the high current pulse that enters the terrestrial body, such that very little energy is absorbed in the terrestrial body during pulsed operation.

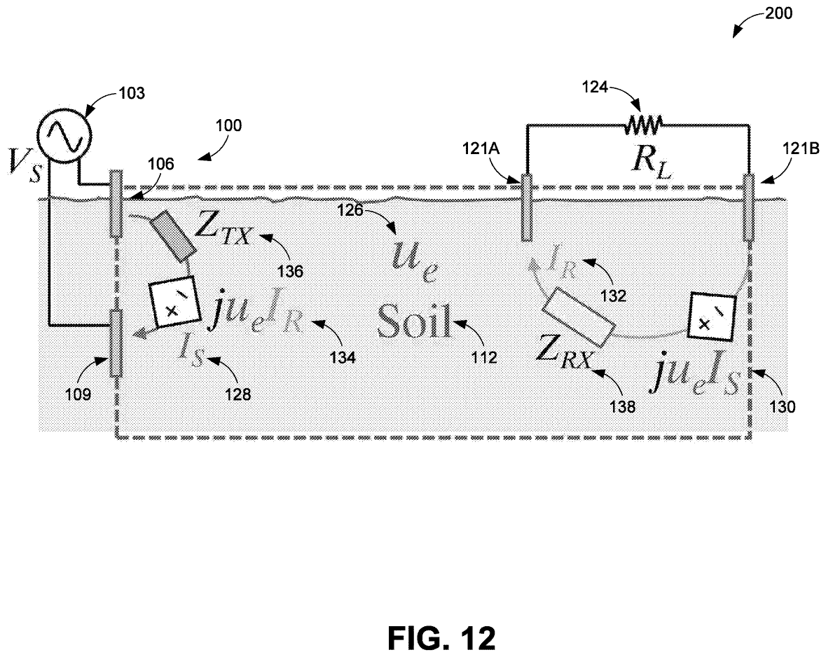

Referring now to FIG. 12, the system 200 can include components of the transmitter circuit 100, as described with reference to FIG. 11, including a power source 103, represented as Vₛ, a first electrode 106, and a second electrode 109. The system 200 can include a first receiver electrode 121A and a second receiver electrode 121B (collectively, the “receiver electrodes 121”) placed in a terrestrial body. In some embodiments, the system 200 can include any number of receiver electrodes (e.g., more than 2). The receiver electrodes 121 can be connected to a load 124, R_{L}. The receiver electrodes 121 and the load 124 can be spaced apart from the transmitter circuit 100 and separated by the soil 112. In some embodiments, as illustrated by FIG. 12, the receiver electrodes 121 can be placed on the surface of the terrestrial body (e.g., spaced horizontally). In some other embodiments, the receiver electrodes 121 can be include an electrode placed on the surface (e.g., a surface electrode) and a second electrode placed vertically underneath the first electrode (e.g., a subsurface electrode spaced vertically from the surface electrode). The load 124 can include any device configured to receive electrical power (e.g., a sensor, monitoring device, communications device).

The terrestrial body may be characterized by a mutual impedance 126, uₑ, representing the coupling between the transmitter circuit 100 and the receiver electrodes 121 through the terrestrial body. The mutual impedance 126 can be dependent on the distance between the transmitter circuit 100 and the receiver electrodes 121, the conductivity of the soil 112, and the operating frequency of the power source 103. In some embodiments, the mutual impedance 126 can decrease as the distance between the transmitter circuit 100 and the receiver electrodes 121 increases.

The transmitter circuit 100 can include a transmitter impedance 136, Z_{TX}, from the perspective of the power source 103. The transmitter impedance 136 can include a resistive component attributable to the contact resistance, R_{contact}. The transmitter impedance 136 can include a first reactive component, X_{down}, attributable to the direct current path between the first electrode 106 and the second electrode 109, and a second reactive component, X_{outward}, attributable to the outward current path through the soil 112. In some embodiments, the transmitter circuit 100 can be configured to minimize the contact resistance, R_{contact}, and the first reactive component, X_{down}, while maximizing the second reactive component, X_{outward}, to satisfy the condition X_{outward}>>R_{contact}, thereby establishing the reactive energy storage condition in the terrestrial body. As will be discussed further, the receive electrodes 121 can couple to the reactive energy storage condition and deliver power to the load 124 due to the reactive energy storage condition. This power delivery removes some of the reactive energy storage in the terrestrial body and consumes it in the load 124

The receiver electrodes 121 can include a receiver impedance 138, Z_{RX}. The receiver impedance 138 may include a resistive component attributable to the contact resistance of the receiver electrodes 121. As will be understood, the contact resistance of the receiver electrodes 121 may vary from the contact resistance, R_{contact}, of the first electrode 106 and the second electrode 109. The receiver impedance 138 can include a reactive component attributable to the outward current path from the transmitter circuit 100. For example, the receiver electrodes 121 can be configured such that the reactive component is maximized compared to the resistive component, thereby creating a coupling effect between the transmitter circuit 100 and the receiver electrodes 121 through the mutual impedance 126.

When the transmitter circuit 100 and the receiver electrodes 121 are configured to satisfy the condition X_{outward}>>R_{contact}, a coupling effect can be established between the transmitter circuit 100 and the receiver electrodes 121 through the mutual impedance 126. For example, the power source 103 can induce a source current 128, I_{S}, through the transmitter circuit 100, the mutual impedance 126 can induce a voltage 130, juₑI_{S} at the receiver electrodes 121, where the voltage 130 can be phase shifted 90 degrees relative to the source current 128. The induced voltage 130 can drive a receiver current 132, IR, through the receiver electrodes 121 and the load 124. In some embodiments, the receiver current may induce a return voltage 134, juₑI_{R}, at the transmitter circuit 100. In some embodiments, the return voltage 134 may be able to reflect the load 124 back to the transmitter circuit 100 such that the power source 103 may be configured to respond to changes to the load 124. In some embodiments, if condition X_{outward}>>R_{contact} is not satisfied, the receive electrodes 121 can be configured for communications and low-power operations, rather than high-power operations.

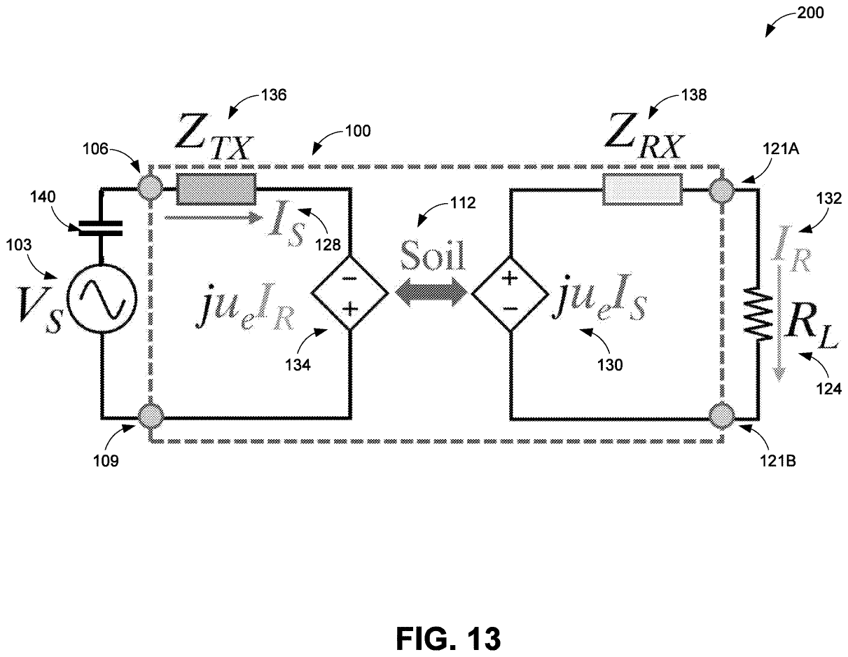

Referring now to FIG. 13, shown is the system 200 illustrated as a circuit. The transmitter circuit 100 can include a capacitor 140 connected in series with the power source 103, the first electrode 106, and the second electrode 109. As will be appreciated, FIG. 13 shows one possible embodiment of the transmitter circuit 100 including the capacitor 140, and other embodiments, including the capacitor 140 in parallel to the transmitter circuit 100, are possible. In some other embodiments, the receive electrodes 121 can include a capacitor in series. The capacitor 140 can be configured to have a capacitive reactance that may cancel out X_{outward} in the transmitter circuit 100, which can direct and maximize the current from the power source 103 to the outward current path. For example, the capacitive reactance of the capacitor 140 can be selected such that the transmitter circuit 100 is configured to drive maximum current through the outward current loops in the terrestrial body and satisfy the condition X_{outward}>>R_{contact}. In some embodiments, the power source 103 may be operated a resonant frequency at which the capacitor 140 is configured to cancel out X_{outward} and satisfy the condition X_{outward}>>R_{contact}. For example, at a resonant frequency, the capacitor 140 can cancel out X_{outward}, which can allow the power source 103 to drive the maximum current through the transmitter circuit 100 at a minimum power input. The resulting reactive energy field oscillating in the terrestrial body may be substantially greater than the active power dissipated in the R_{contact} of the transmitter circuit 100. As an illustrative, non-limiting example, the transmitter circuit 100 may establish a reactive energy field of 30 volt-ampere reactive (VAR) or greater in the terrestrial body, which may be available to power the load 124 connected to the receiver electrodes 121. For example, a minimal or negligible amount of energy may be dissipated in the terrestrial body. In this non-limiting, illustrative example, the transmitter circuit 100 can be configured to dissipate 1 watt due to R_{contact}. Thus, at a resonant frequency, the power transfer can be maximized and out of phase with the power source 103 with a minimal amount of energy being dissipated into the terrestrial body. For example, the resonant frequency can include continuous waveforms and may use FM or AM modulation for communication purposes. In some other embodiments, if the resonant frequency is not achieved, the capacitor 140 can be configured to reduce X_{outward} such that a non-linear waveform can be injected into the terrestrial body.

The power source 103 can be operated within a frequency range to satisfy the condition X_{outward}>>R_{contact}. For example, X_{outward} can be defined as:

$${X}_{outward} = ω L = 2 π f L \qquad ( 4 )$$

where ω represents an angular frequency, L represents the inductance, and f represents the frequency. Therefore, the minimum frequency that satisfies the condition X_{outward}>>R_{contact} can be defined as:

$${f}_{min} \geq \frac{{R}_{c o n t a c t}}{2 π L} \qquad ( 5 )$$

with R_{contact} representing the contact resistance and L representing the inductance formed from current traveling within the terrestrial body.

In embodiments below the minimum frequency, X_{outward} may be insufficient to exceed the contact resistance, R_{contact}. In some embodiments, the minimum frequency may be lowered by reducing the contact resistance, R_{contact} through the geometry of the first electrode 106 and the second electrode 109, by increasing L through a larger outward current path (e.g., current loops), or both. For example, the ratio of the reactance to the contact resistance, R_{contact}, can be high to achieve the minimum frequency.

The maximum frequency can be defined by the near-field constraint, where the transmission radius, r, may be no greater than one-tenth of the wavelength, λ, of the AC signal from the power source 103. As will be understood, frequency is proportional to velocity, v, of the wave in the medium of the terrestrial body divided by wavelength, λ. Therefore, the maximum frequency can be defined as:

$${f}_{max} \leq \frac{v}{10 r} \qquad ( 6 )$$

As will be understood, the resonant frequency at which the capacitor 140 is configured to cancel out X_{outward} and satisfy the condition X_{outward}>>R_{contact} can be any frequency between the minimum frequency and the maximum frequency. In some embodiments, the operating frequency may fall within the extremely low frequency to low frequency range, corresponding to approximately 30 Hz to 300 kHz for terrestrial applications on earth. On other terrestrial bodies, the operating frequency range may be higher or lower depending on the electrical properties of the terrestrial body.

For example, the frequency can be selected such that the transmitter circuit 100 optimally operates in a near-field regime, rather than a far-field regime. To operate in the near-field regime, the electrode separation (e.g., the distance between the first electrode 106 and the second electrode 109), d, may be no greater than one-tenth of the wavelength, λ, of the AC signal from the power source 103. In some embodiments, when the transmitter circuit 100 operates in a far-field regime, rather than a near-field regime, energy is radiated outward from the transmitter circuit 100 as electromagnetic waves rather than being stored reactively in the terrestrial body, resulting in rapid attenuation of the signal through the conductive terrestrial body and a significant reduction in power transfer efficiency.

Referring now to FIG. 14, shown is an experimental system 300. As will be understood, the experimental system 300 merely presents one possible experimental system, and other systems may be possible. For example, the experimental system 300 described herein represents only one possible embodiment of the disclosure and is provided for illustrative and explanatory purposes only. The specific dimensions, electrode configurations, operating frequencies, impedance values, and separation distances described in connection with the experimental system 300 are not intended to limit the scope of the disclosure, and other embodiments may employ different configurations while remaining within the scope of the claims.

The system 300 can include a transmitter electrode structure 303, Tx. In some embodiments, the transmitter electrode structure 303 can include the transmitter circuit 100 as described herein. The system 300 can include a first receiver electrode structure 306, RX₁, and a second receiver electrode structure 309, RX₂. For example, the first receiver electrode structure 306 and the second receiver electrode structures 309 can include the receiver electrodes 121 as described herein. The first receiver electrode structure 306 and the second receiver electrode structures 309 can each be spaced approximately 45 meters from the transmitter electrode structure 303. The transmitter electrode structure 303 and the second receiver electrode structure 309 can include a 15-meter-long surface electrode and a 15-meter-long subsurface electrode, where the subsurface electrode is placed 60 meters below the surface electrode. The first receiver electrode structure 306 can include a 2-meter-long surface electrode and a 2-meter-long subsurface electrode, where the subsurface electrode is placed 60 meters below the surface electrode. For example, the first receiver electrode structure 306 can have a complex impedance of approximately Z≈60+j31Ω, wherein the resistive component dominated the reactive component. As another example, the second receiver electrode structure 309 can have a complex impedance of approximately Z≈20+j31Ω, wherein the reactive component dominated the resistive component.

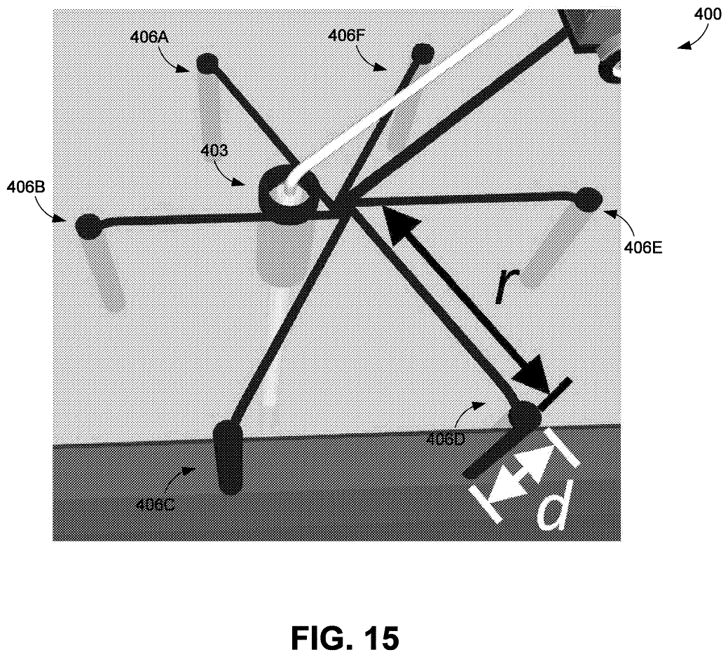

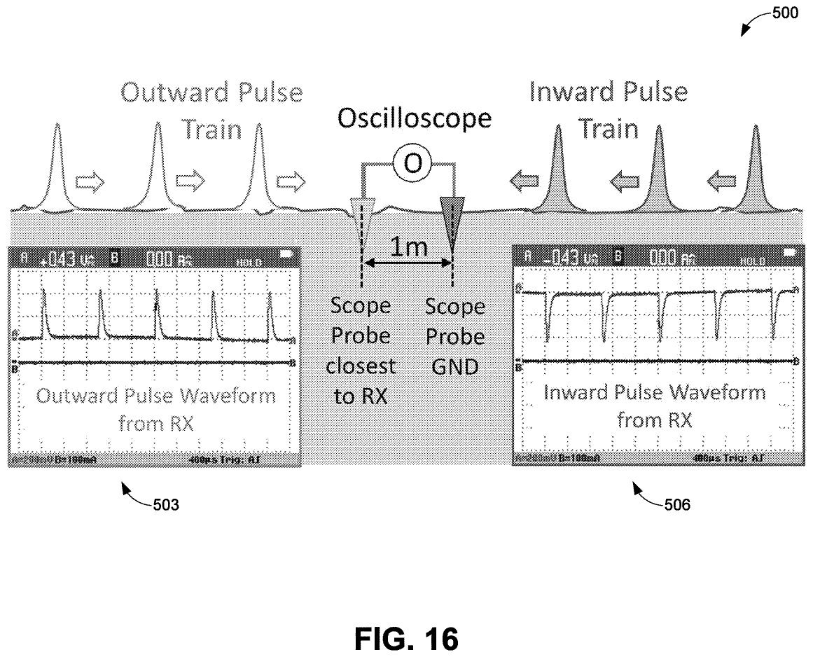

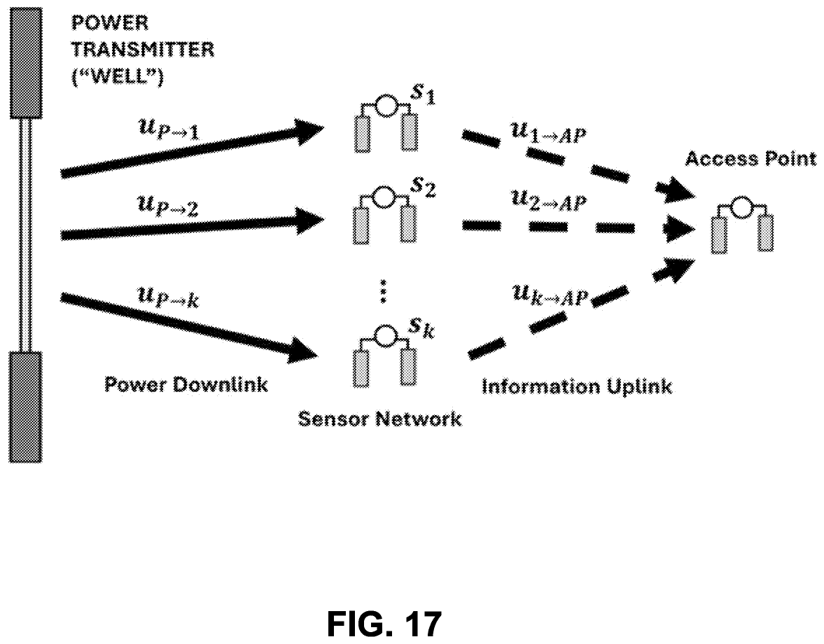

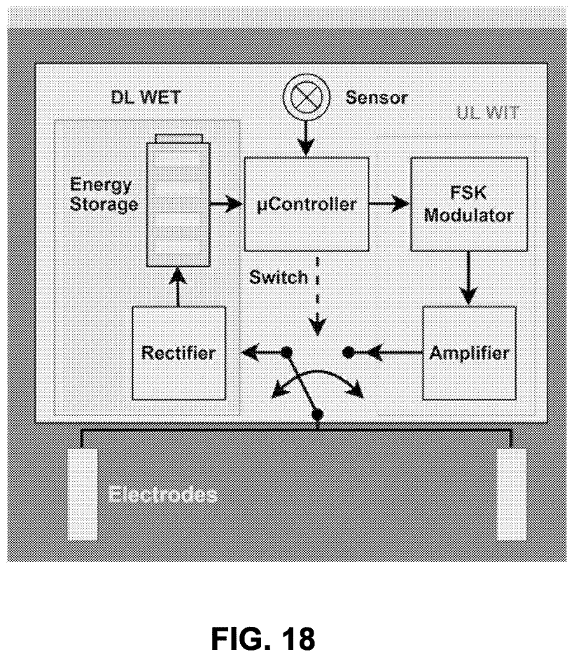

Referring now to FIG. 15, shown is a surface electrode configuration 400. For example, the configuration 400 can be used for each of the surface electrodes for the transmitter electrode structure 303, first receiver electrode structure 306, and the second receiver electrode structures 309 as described with reference to FIG. 14. For example, each of the surface electrodes can be configured as star electrode, which can include a central bore casing 403 and multiple grounding rods 406. The ground rods 406 can be connected to the central bore casing 403 extending radially outward from the central bore casing 403. Each grounding rod 406 can have a length d and may be driven into the terrestrial body at the radial distance r from the central bore casing 403. In some embodiments, the surface electrode configuration 400 may be configured to minimize the contact resistance R_{contact} at the transmitter electrode-soil interface by maximizing the surface area of the surface electrode in contact with the terrestrial body. In some embodiments, increasing the number of grounding rods 406, increasing the length d of each grounding rod, and/or increasing the radial distance r of the grounding rods 406 from the central bore casing 403 may further reduce the contact resistance R_{contact}.

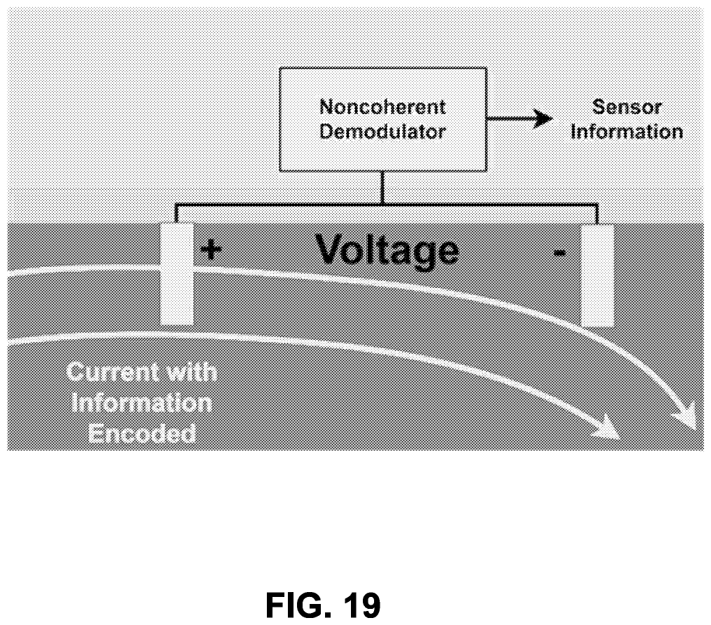

Referring now to FIG. 16, shown are experimental results 500 using the experimental system 300 and the surface electrode configuration 400. For example, the experimental results 500 can include the waveforms 503 for the first receiver electrode structure 306 and the waveforms 506 for the second receiver electrode structures 309. For example, the step-potential distribution around the first receiver electrode structure 306 and the second receiver electrode structure 309 was measured at distances of 3, 6, and 9 meters from each respective electrode receiver structure, wherein an oscilloscope or similar measurement device may be used to measure the step-potential distribution in the terrestrial body. As an illustrative, non-limiting example, the transmitter electrode structure 303 can be configured to transmit a 1 kHz outward flowing conduction current pulse train through the terrestrial body. Continuing with this example, an outward diverging scattering pulse was observed around the first receiver electrode structure 306 due to the complex impedance of the first receiver electrode structure 306 being predominantly resistive. The outward diverging scattering pulse can indicate that no coupling occurred between the first receiver electrode structure 306 and the transmitter electrode structure 303. Continuing with this example, an inward converging re-emission pulse was observed around the second receiver electrode structure 309 due the complex impedance of the second receiver electrode structure 309 being predominantly reactive. The inward converging re-emission pulse can indicate that coupling was established between the second receiver electrode structure 309 and the transmitter electrode structure 303. For example, the inward converging re-emission pulse around the second receiver electrode structure 309 can indicate that a reactive energy storage condition was established in the terrestrial body and satisfy the condition X_{outward}>>R_{contact}.

The following is a non-limiting example of Wireless Power Transfer (WPT), a promising solution for long-range underground power delivery using conduction currents rather than radiative fields. The following presents an underground wireless powered communication network (WPCN) that leverages WPT for both energy transfer and data communication. The data and communication may be transferred through a terrestrial body, e.g., through soil, rock, water, etc. A system model is discussed in this example that aligns WPT with existing simultaneous wireless information and power transfer (SWIPT) frameworks, allowing analysis of key performance metrics. Additionally, a receiver assembly is demonstrated, which is able to achieve bit error rates and channel capacity over distance. This example thus illustrates WPCNs for applications such as long-term, battery-free underground sensing applications.

FIG. 17 shows an example wireless powered communication network in accordance with one embodiment, including a power transmitter (“well”), which can transmit power wirelessly to one or more sensors. The sensors, in turn, can communicate information to an access point, e.g., powered using power received from the power transmitter.

FIG. 18 shows a non-limiting example of an underground sensor, e.g., as part of a receiver assembly. In this example, power is received through one or more electrodes, and may be stored, for example, in a battery or other energy storage device. The power may be directed to a sensor, controlled by a microcontroller or other suitable controller (for example, a computer), and information about the sensor may be transmitted wirelessly, for example using an FSK modulator, or other suitable modulator such as any of those disclosed herein. Such communication (e.g., about the sensor) may be amplified, e.g., using an amplifier, before being transmitted wirelessly using the electrodes. In some cases, a switch (e.g., controlled by the controller) may be used to coordinate the receiver assembly between receiving power and transmitting communications.

FIG. 19 illustrates an access point receiver as a non-limiting example. Information from a wireless communication may be determined using one or more electrodes, and decoded, e.g., using a demodulator to allow the communication from the sensor to be determined.

Thus, although there have been described particular embodiments of the present disclosure of a new and useful SYSTEMS AND METHODS FOR TRANSMITTING COMMUNICATIONS AND POWER OVER LONG DISTANCES THROUGH TERRESTRIAL SUB-SURFACES, it is not intended that such references be construed as limitations upon the scope of this disclosure.

What is claimed is:

1. A system, comprising:
a transmitter electrode structure configured to be positioned with a terrestrial body, wherein the transmitter electrode structure comprises:
a first electrode; and
a second electrode spaced a distance from the first electrode; and
a power source electrically connected to the transmitter electrode structure and configured to drive an alternating current through the transmitter electrode structure and into the terrestrial body;
wherein the transmitter electrode structure is configured such that an inductive reactance of an outward current path exceeds a contact resistance of the transmitter electrode structure, and wherein the alternating current flows through the outward current path to establish a reactive energy storage condition in the terrestrial body.

2. The system of claim 1, wherein the first electrode is positioned proximately to an upper surface of the terrestrial body.

3. The system of claim 1, wherein the second electrode in positioned under the first electrode in the terrestrial body.

4. The system of claim 1, further comprising a capacitor electrically connected to the transmitter electrode structure.

5. The system of claim 4, wherein the capacitor is configured to minimize an inductive reactance of a direct current between the first electrode and the second electrode.

6. The system of claim 4, wherein the power source is configured to operate at a resonant frequency, and the capacitor is configured to direct the alternating current to the outward current path.

7. The system of claim 1, wherein the power source is configured to operate within a frequency range defined by a minimum frequency and a maximum frequency.

8. The system of claim 7, wherein the minimum frequency is defined by the contact resistance and an inductance of the outward current path.

9. The system of claim 7, wherein the maximum frequency is defined a transmission radius.

10. The system of claim 9, wherein the transmission radius is configured to be less than one-tenth of a wavelength of the alternating current.

11. A system, comprising:
a transmitter electrode structure configured to be positioned with a terrestrial body, wherein the transmitter electrode structure comprises:
a first electrode; and
a second electrode spaced a first distance from the first electrode;
a power source electrically connected to the transmitter electrode structure and configured to drive an alternating current through the transmitter electrode structure and into the terrestrial body;
a receiver electrode structure configured to be positioned within the terrestrial body and spaced apart from the transmitter electrode structure; and
a load electrically connected to the receiver electrode structure
wherein the transmitter electrode structure is configured such that an inductive reactance of an outward current path away exceeds a contact resistance of the transmitter electrode structure, wherein the alternating current flows through the outward current path to establish a reactive energy storage condition in the terrestrial body, and wherein the receiver electrode structure is configured to couple to the reactive energy storage condition established in the terrestrial body and deliver power to the load.

12. The system of claim 11, wherein the receiver electrode structure comprises a first receiver electrode configured to be placed in the terrestrial body, and a second receiver electrode configured to be placed in the terrestrial body spaced a second distance away from the first electrode.

13. The system of claim 11, wherein the receiver electrode structure is configured such that a reactive component of the receiver electrode structure dominates a resistive component of the receiver electrode structure.

14. The system of claim 13, wherein the reactive component of the receiver electrode structure is configured to establish a coupling effect with the transmitter electrode structure through the terrestrial body.

15. The system of claim 11, wherein the load comprises a sensor or a monitoring device.

16. The system of claim 11, wherein the power source is configured to operate in a pulsed mode or a continuous waveform mode.

17. A device, comprising:
a surface electrode configured to be placed in a terrestrial body;
a subsurface electrode configured to be placed in the terrestrial body and spaced a distance from the surface electrode, wherein the subsurface electrode is electrically connected to the surface electrode via the terrestrial body; and
a power source configured to drive an alternating current through the surface electrode and the subsurface electrode;
wherein the surface electrode and the subsurface electrode are configured to establish a reactive energy storage condition in the terrestrial body in response to the alternating current.

18. The device of claim 17, wherein the surface electrode comprises a central casing bore and a plurality of grounding rods.

19. The device of claim 18, wherein each of the plurality of grounding rods are placed a distance from the central casing bore.

20. The device of claim 18, wherein the central casing bore and the plurality of grounding rods are configured to decrease a contact resistance of the surface electrode in the terrestrial body.

21. A method, comprising:
providing a transmission device and a receiver assembly, each at least partially embedded in a lossy dielectric medium, separated by a distance of at least 1 m, the transmission device comprising a first electrode, at least one second electrode spaced a distance from the first electrode, and a power source operable to supply power to the first electrode and the at least one second electrode, wherein the power source comprises an electric inverter configured to shape an input power waveform from the power source into an electric wave signal supplied to the transmitter;
causing the transmission device to produce an electric wave signal that propagates through the lossy dielectric medium;
receiving the propagating electric wave signal from the lossy dielectric medium into the receiver assembly; and
decoding the propagating electric wave as a wireless communication between the transmission device and the receiver assembly.

22. The method of claim 21, further comprising transmitting power from the transmission device to the receiver assembly.

23. The method of claim 22, wherein the power and the wireless communication are transmitted simultaneously from the transmission device to the receiver assembly.

24. The method of claim 22, wherein the power and the wireless communication are not transmitted simultaneously from the transmission device to the receiver assembly.

25. The method of claim 21, further comprising a modulator configured to modulate the power supplied to the first electrode and the at least one second electrode to encode the wireless communication to be transmitted by the transmission device.

26. The method of claim 25, wherein the modulator comprises a Frequency-Shift Keying (FSK) modulator.

27. The method of claim 26, wherein the FSK modulator is a Binary Frequency-Shift Keying (BFSK) modulator.

28. The method of claim 25, wherein the modulator comprises a pulse position modulator.

29. The method of claim 25, wherein the modulator comprises an amplitude modulator.

30. The method of claim 25, wherein the modulator comprises a frequency modulator.

31. The method of claim 25, wherein the modulator comprises a Morse code modulator.

32. The method of claim 21, wherein the lossy dielectric medium is a terrestrial body.

33. The method of claim 21, wherein the receiver assembly comprises:
a first receiver electrode; and
at least one second receiver electrode spaced from the first receiver electrode.

34. The method of claim 33, wherein the at least one second receiver electrode is spaced a distance of at least 10 meters from the first receiver electrode.

35. The method of claim 21, wherein the first electrode and the at least one second electrode are spaced a distance of at least 1 m.

36. The method of claim 21, wherein the transmitter comprises at least two second electrodes.

37. The method of claim 36, wherein a spacing between two of the second electrodes is at least 10 m.

38. The method of claim 21, wherein the electric wave signal is non-linear.

39. The method of claim 21, wherein the at least one second electrode is spaced a vertical distance downward from the first electrode.

40. A method, comprising:
providing a transmission device and a receiver assembly, each at least partially embedded in a lossy dielectric medium, separated by a distance of at least 1 m, the transmission device comprising a first electrode, at least one second electrode spaced a distance from the first electrode, and a power source operable to supply power to the first electrode and the at least one second electrode, wherein the power source comprises an electric inverter configured to shape an input power waveform from the power source into an electric wave signal supplied to the transmitter;
modulating the transmission device to produce an electric wave signal that propagates through the lossy dielectric medium; and
receiving the propagating electric wave signal from the lossy dielectric medium into the receiver assembly.

41. The method of claim 40, comprising modulating a pulse repetition rate of the electric wave signal.

42. The method of claim 40, wherein the electric wave signal encodes a wireless communication.

43. A device, comprising:
a transmitter comprising:
a first electrode, and
at least one second electrode spaced from the first electrode,
wherein the transmitter is configured to be installable such that at least one of the second electrodes is spaced a distance from the first electrode; and
a power source operable to supply power to the first electrode and the at least one second electrode, wherein the power source comprises an electric inverter configured to shape a communication and an input power waveform from the power source into an electric wave signal encoding the communication that is supplied to the transmitter.
